(19) United States
(12) Patent Application Publication
(10) Pub. No.: US 2013/0048541 A1
(43) Pub. Date: Feb. 28, 2013

(54) ATTRITION SELECTIVE PARTICLES

(71) Applicant: Dong X. Li, San Ramon, CA (US)

(72) Inventor: Dong X. Li, San Ramon, CA (US)

(73) Assignee: Chevron U.S.A. Inc., San Ramon, CA (US)

(21) Appl. No.: 13/596,560

(22) Filed: Aug. 28, 2012

Related U.S. Application Data
(60) Provisional application No. 61/528,325, filed on Aug. 29, 2011.

(51) Int. Cl. B01J 35/02; B01J 21/04; B01J 38/22; B01J 29/04; B01J 37/04; B01J 21/10; C10G 11/02; B01J 27/02

(52) U.S. Cl. 208/113; 502/100; 502/355; 502/216; 502/223; 502/60; 502/77; 502/340; 502/45

(57) ABSTRACT

Additive particles for use in a fluid catalytic cracking system are provided for reducing the opacity of flue gas that is generated from a regenerator within the system. Particles are supplied to the unit to catalyze the cracking of hydrocarbon feeds, and to react with sulfur oxides that are produced during regeneration of catalysts supplied for the cracking reactions. At least a portion of the supplied particles include active particulates and a binder, with at least a portion of the active particulates being in a size range from 0.5 to 40 microns.

### CROSS-REFERENCE TO A RELATED APPLICATION

The present application for patent claims the benefit of U.S. provisional patent application bearing Ser. No. 61/528,325, filed on Aug. 29, 2011, which is incorporated by reference in its entirety.

### TECHNICAL FIELD

The present invention relates to a method for controlling particulate matter emission in flue gases generated in catalyst regenerators in hydrocarbon fluid catalytic cracking systems.

### BACKGROUND

Modern hydrocarbon fluid catalytic cracking (FCC) systems use a moving bed or circulating fluidized bed of a particulate catalyst. FIG. 1 is a schematic representation of an example hydrocarbon fluid catalytic cracking system 2. Catalytic cracking is carried out in the absence of externally supplied molecular hydrogen, and is thereby distinguished from hydrocracking, in which hydrogen is added. In catalytic cracking, catalyst is subjected to a continuous cyclic cracking reaction and catalyst regeneration procedure. In a FCC system, a stream of hydrocarbon feed 4 is contacted with fluidized catalyst particles in a hydrocarbon cracking zone, or reactor 6, usually at a temperature of about 425° Celsius (797 degree Fahrenheit) to 700° Celsius (1292 degree Fahrenheit). The hydrocarbons in the hydrocarbon feed react with the fluidized catalyst particles at this temperature resulting in deposition of carbonaceous coke on the catalyst particles. The resulting cracked hydrocarbon fluid products 8 are thereafter separated from the coked catalyst 10 and are withdrawn from the cracking zone. The coked catalyst 10 is stripped of volatiles, usually with steam, and is cycled to a catalyst regenerator 12. In the catalyst regeneration zone, the coked catalyst 10 is contacted with a gaseous fluid 14, such as air, which contains a predetermined concentration of molecular oxygen to burn off a desired portion of the coke from the catalyst and simultaneously to heat the catalyst to a high temperature desired when the catalyst is again contacted with the hydrocarbon feed 4 in the cracking zone. After regeneration, the catalyst 16 is cycled to the cracking zone, where it is used to vaporize the hydrocarbon feed 4 and to catalyze hydrocarbon cracking in reactor 6. The flue gas 18 formed by combustion of coke in the catalyst regenerator is removed from the regenerator. Flue gas 18 may be treated to remove particulates and carbon monoxide, after which it is normally passed into the atmosphere. Concern with the emission of particulate matter in flue gas 18, such as sulfur oxides, has resulted in a search for improved methods for controlling such particulate matter emissions.

The amount of conversion obtained in an FCC cracking operation is the volume percent of fresh hydrocarbon feed changed to gasoline and lighter products during the conversion step. The end boiling point of gasoline for the purpose of determining conversion is conventionally defined as 221° Celsius (429.8 degree Fahrenheit). Conversion is often used as a measure of the severity of a commercial FCC operation. At a given set of operating conditions, a more active catalyst gives a greater conversion than does a less active catalyst. The ability to provide higher conversion in a given FCC unit is desirable in that it allows the FCC unit to be operated in a more flexible manner. Feed throughput in the unit can be increased, or alternatively a higher degree of conversion can be maintained with a constant feed throughput rate. The type of conversion, i.e., selectivity, is also important in that poor selectivity results in less naphtha, the desired cracked product, and higher gas and coke makes.

Hydrocarbon feeds processed in commercial FCC units normally contain sulfur, usually termed “feed sulfur.” A portion of the feed sulfur in a hydrocarbon feed processed in an FCC system is invariably transferred from the feed to the catalyst particles as a part of the coke formed on the fluidized catalyst particles during cracking. The sulfur deposited on the catalyst, herein termed “coke sulfur,” is passed from the cracking zone on the coked catalyst into the catalyst regenerator. About 2-10% or more of the feed sulfur is continuously passed from the cracking zone into the catalyst regeneration zone in the coked catalyst. In an FCC catalyst regenerator, sulfur contained in the coke is burned along with the coke carbon, forming gaseous sulfur dioxide and sulfur trioxide, which are conventionally removed from the regenerator in the flue gas.

Most of the feed sulfur does not become coke sulfur in the cracking reactor. Instead, it is converted either to normally gaseous sulfur compounds such as hydrogen sulfide and carbon oxysulfide, or to normally liquid organic sulfur compounds. All these sulfur compounds are carried along with the cracked hydrocarbon fluid products recovered from the cracking reactor. About 90% or more of the feed sulfur is continuously removed from the cracking reactor in the stream of processed, cracked hydrocarbons, with about 40-60% of this sulfur being in the form of hydrogen sulfide. Provisions are conventionally made to recover hydrogen sulfide from the effluent of the cracking reactor. Typically, a very-low-molecular-weight off-gas vapor stream is separated from the C₃+liquid hydrocarbons in a gas recovery unit, and the off-gas is treated, as by scrubbing it with an amine solution, to remove the hydrogen sulfide. Removal of sulfur compounds such as hydrogen sulfide from the fluid effluent from the FCC cracking reactor, e.g., by amine scrubbing, is relatively simple and inexpensive, relative to removal of sulfur oxides from the FCC regenerator flue gas by conventional methods. Moreover, if all the sulfur which must be removed from the hydrocarbon feed in a FCC operation could be recovered in a single operation performed on the reactor off-gas, the use of plural sulfur recovery operations in a FCC unit could be obviated, reducing expense.

It has been suggested to diminish the amount of sulfur oxides in FCC regenerator flue gas by desulfurizing a hydrocarbon feed in a separate desulfurization unit prior to cracking or to desulfurize the regenerator flue gas itself, by a conventional flue gas desulfurization procedure, after its removal from the FCC regenerator. Clearly, either of the foregoing alternatives requires an elaborate, extraneous processing operation and entails large capital and utilities expenses.

If sulfur normally removed from the FCC unit as sulfur oxides in the regenerator flue gas is instead removed from the cracking reactor as hydrogen sulfide along with the processed cracked hydrocarbons, the sulfur thus shifted from the regenerator flue gas to the reactor effluent constitutes simply a small increment to the large amount of hydrogen sulfide and organic sulfur invariably present in the reactor effluent. The small added expense, if any, of removing even as much as 5-15% more hydrogen sulfide from an FCC reactor off-gas by available means is substantially less than the expense of reducing the flue gas sulfur oxide levels by separate feed desulfurization. Present commercial facilities for removing hydrogen sulfide from reactor off-gas can, in most if not all cases, handle any additional hydrogen sulfide which would be added to the off-gas if the sulfur normally discharged in the regenerator flue gas were substantially all shifted to form hydrogen sulfide in the FCC reactor off-gas. Sulfur oxide (SOₓ) additives are known for directing feed sulfur into the fluid cracked products removal pathway from the cracking reactor and thereby, reducing the amount of sulfur oxides in the regenerator flue gas. However, in some cases, use of SOₓ additives increases the opacity and/or the particulate matter emissions of regenerator flue gases, even with the use of highly efficient methods for removing particles from the flue gas.

The FCC regenerator flue gas contains significant amounts of solid particles that are produced from attrition of the circulating inventory of particles within the FCC system. A substantial portion of these solid particles originate from attrition of the catalyst particles within the circulating inventory during FCC operation. The attrited particles are of a size to be carried along with the flue gas, from the regenerator and into flue gas particle cleanup. SOₓ additives which are included in the circulating inventory of solid particles also contribute to the particle emissions from the regenerator.

Some progress has been achieved in reducing the impact of particle attrition through the development of attrition resistant catalysts and SOₓ additives. Downstream gas clean-up, using emission control technologies such as cyclones, electrostatic precipitators (ESP), wet scrubbers, or a combination of these, has been used to further reduce particle emissions. However, cyclones have limited capability to remove fine particles that are less than 10 microns (μm), i.e. 393.7 microinches (μin) in size. Electrostatic precipitator (ESP) units are also very effective for removing particles having a size of greater than 10 μm (393.7 μin) from regenerator flue gas. Removal efficiencies for ESP units for microfine particles in the range from 1 μm (39.37 μin) to 10 μm (393.7 μin) decrease with decreasing particle size through this size range, though modern ESP units are generally capable of meeting current emission standards with respect to particles within this range. ESP removal efficiency of submicrofine particles, having a size between 0.8 μm (31.5 μin) and 0.2 μm (7.874 μin), is often poor, resulting in flue gas that may not meet emission standards either for opacity or for particulate matter, especially fine particulate matter having a size less than 2.5 μm (98.43 μin). Wet scrubbers are capable in removing both SOₓ and particles. However, they are not only costly to install and use, but also generate a wastewater stream that will require additional treatment. Wet scrubbers also have limited efficiency for removal of fine particulate matter having a size less than 2.5 μm (98.43 μin).

Sulfur oxide (SOₓ) additives also contribute to particle emissions from FCC systems. In some systems, a significant increase in opacity of regenerator flue gas streams has been observed when SOₓ additives were included in the circulating inventory of solid particles. It is desirable to develop SOₓ additives that reduce the opacity and fine particulate matter emissions impact during FCC operation, while maintaining acceptable levels of SOₓ removal activity.

### SUMMARY

Accordingly, the present invention provides additive particles for use in a fluid catalytic cracking system. The additive particles comprise active particulates and a binder material. In embodiments, at least a portion of the active particulates are in a size range from 0.5 μm (19.69 μin) to 40 μm (1575 μin). In some such embodiments, at least 50 wt. % of the active particulates are in a size range from 0.5 μm (19.69 μin) to 40 μm (1575 μin). In embodiments, at least a portion of the additive particles are in a size range from 45 μm (1772 μin) to 200 μm (7874 μin). In some such embodiments, at least 50 wt. % of the additive particles are in a size range from 45 μm (1772 μin) to 200 μm (7874 μin).

Further to the invention is a process for preparing additive particles. In embodiments, this preparation process includes forming active particulates, at least a portion of which are in a size range from 0.5 μm (19.69 μin) to 40 μm (1575 μin); and combining at least a portion of the active particulates with a binder material to form additive particles, at least a portion of which are in a size range from 45 μm (1772 μin) to 200 μm (7874 μin). In some such embodiments, at least 50 wt. % of the active particulates are in a size range from 0.5 μm (19.69 μin) to 40 μm (1575 μin). In some such embodiments, the additive particles are prepared such that at least 50 wt. % of the additive particles are in a size range from 45 μm (1772 μin) to 200 μm (7874 μin).

Further to the invention is a fluid catalytic cracking process comprising circulating a mixture of cracking catalyst and SOₓ additive particles within a fluid catalytic cracking unit which includes a catalyst regeneration unit, passing an oxygen-containing gaseous fluid through the catalyst regeneration unit, and producing a flue gas stream. In embodiments, at least a portion of the cracking catalyst is in the form of cracking particles comprising active cracking particulates and a binder material. In some such embodiments, at least a portion of the cracking particles are in a size range from 45 μm (1772 μin) to 200 μm (7874 μin). In some such embodiments, at least 50 wt. % of the cracking particles are in a size range from 45 μm (1772 μin) to 200 μm (7874 μin). In some such embodiments, at least a portion of the active cracking particulates are in a size range from 0.5 μm (19.69 μin) to 40 μm (1575 μin). In some such embodiments, at least 50 wt. % of the active cracking particulates are in a size range from 0.5 μm (19.69 μin) to 40 μm (1575 μin).

Further to the invention is a fluid catalytic cracking process that produces a flue gas with reduced opacity and/or fine particulate matter emissions. In embodiments, the fluid catalytic cracking process comprises circulating a mixture of cracking catalyst and SOₓ additive particles within a fluid catalytic cracking unit that includes a catalyst regeneration unit, passing an oxygen-containing gaseous fluid through the catalyst regeneration unit, and producing a flue gas that contains particulate fragments, including catalyst fragments and SOₓ additive fragments, wherein at least 50 wt. % of the SOₓ additive fragments have a particle size of greater than 0.5 μm (19.69 μin). In some such embodiments, at least 50 wt. % of the catalyst fragments have a particle size of greater than 0.5 μm (19.69 μin).

Further to the invention is a process for cracking a sulfur-containing hydrocarbon feed in the absence of externally supplied molecular hydrogen. Included in the process are the steps of: cycling an inventory of particulate solids including acidic cracking catalyst particles between a cracking zone and a catalyst regeneration zone; cracking the sulfur-containing hydrocarbon feed in the cracking zone in contact with the cracking catalyst particles at cracking conditions including a temperature in the range from about 425° Celsius (797 degree Fahrenheit) to 700° Celsius (1292 degree Fahrenheit), whereby sulfur-containing coke is deposited on the catalyst particles, and removing the cracked hydrocarbon product from the cracking zone; passing the cracking catalyst particles deposited with the sulfur-containing coke from the cracking zone and an oxygen-containing gaseous fluid into the catalyst regeneration zone, burning the sulfur-containing coke therein at a temperature in the range from 538° Celsius (1000 degree Fahrenheit) to 816° Celsius (1501 degree Fahrenheit) to form a flue gas containing sulfur oxides, and removing the flue gas from the catalyst regeneration zone; forming a sulfur-containing solid in the regeneration zone by reacting the sulfur oxides with SOₓ additive particles, comprising at least one SOₓ active particulate having a size range from 0.5 μm (19.69 μin) to 40 μm (1575 μin) and a binder, in the particulate solids inventory other than the catalyst particles; returning the resulting coke-depleted catalyst particles and the sulfur-containing solid from the catalyst regeneration zone to contact with the hydrocarbon feed in the cracking zone; and forming hydrogen sulfide in the cracking zone by contacting the sulfur-containing solid with the hydrocarbon feed.

Further to the invention is a process for combusting a sulfur-containing material in a circulating bed of particulates. In embodiments, the process includes contacting a sulfur-containing material with an oxygen-containing gaseous fluid and producing a gaseous product comprising sulfur oxides; contacting the sulfur oxides with SOₓ additive particles comprising SOₓ active particulates, having a size range from 0.5 μm (19.69 μin) to 40 μm (1575 μin), and a binder; and forming sulfur-containing solids.

### BRIEF DESCRIPTION OF THE DRAWINGS

FIG. 1 is a schematic of an example hydrocarbon fluid catalytic cracking system.

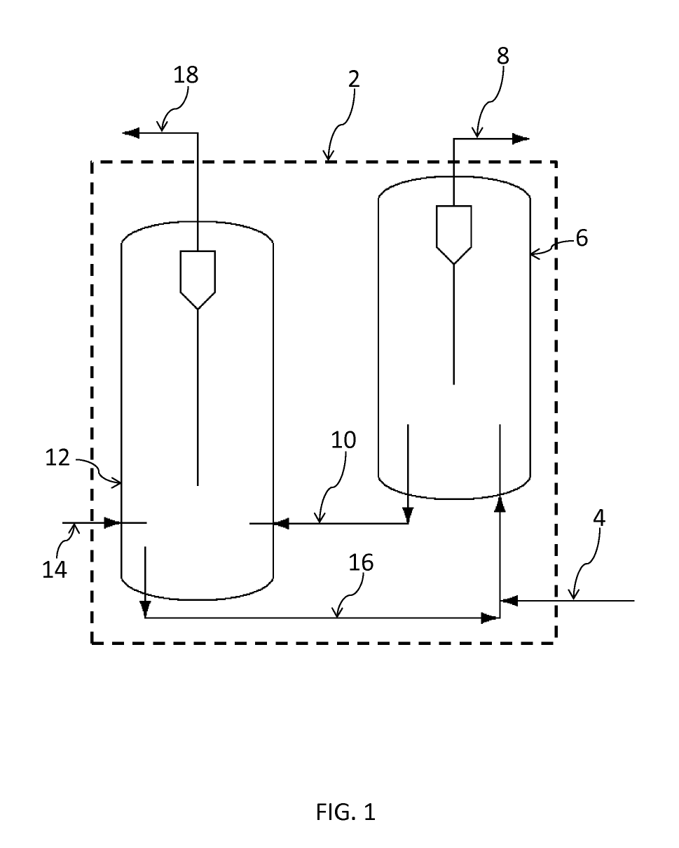

### DETAILED DESCRIPTION

The present invention is directed to additive particles for use in a fluid catalytic cracker (FCC). The additive particles provide one or more beneficial functions within a FCC reactor, including catalyzing the cracking of hydrocarbon feeds within the reactor and/or effecting the recovery of acid gases that would otherwise be vented into the atmosphere during operation of the FCC, such that a reduced amount of additive particles fragments are released to the atmosphere.

Opacity and fine particulate matter emissions of FCC regenerator flue gas relates to the amount of particulate matter in the flue gas which is not captured by particulate control means such as an electrostatic precipitator (ESP). The opacity is the result, in part, of the total particulate matter load on the ESP. The opacity is also governed in part by the size of particulate matter. The attrition of FCC catalyst and other additives is believed to follow two breakage mechanisms in a fluidized bed: particle fracture and abrasion. Particle breakage can occur by compressive failure as by crushing, tensile failure as by collision, and shear failure as by abrasion. Particle collision, and to some extent, abrasion are processes that can cause particle breakage in a fluidized bed. The particle, when it collides with another particle or a wall, is exposed to very high stresses rapidly. The fracture occurs when the stresses exceed its tensile strength. Particle fracture breakage, depending on the collision speed, tends to produce two or more similar sized fragments. The abrasive interaction between particles produces many fines.

The present invention is based in part on the discovery that the submicron fines (i.e., <1 μm (39.37 μin)) generated from the attrition process are primarily produced from abrasion mechanisms. The size range of the attrition fines is often narrowly distributed, and differs for different starting catalyst and other additive particles. Accordingly, the present invention relates to additive particles, which may include catalyst particles, that undergo breakage mechanisms which minimize the production of attrition particles having particle sizes of less than 1 μm (39.37 μin), in a size range below which the particle control devices for FCC regenerator flue gas, such as an ESP, have reduced collection efficiency. In embodiments, the additive particles have micron-sized subunits of active components and a binder which is modified to yield micron-sized fragments rather than submicron-sized fines, allowing improved capture by particle capture processes.

### Additive Particles

The additive particles comprise at least two components, which are distinguishable either by their location within the particles, their chemical composition or by the order in which they are supplied during preparation of the particles. In embodiments, the additive particles comprise at least one active particulate and a binder material. The active particulates generally are in a size range from 0.5 μm (19.69 μin) to 40 μm (1575 μin). In embodiments, the active particulates are in a size range from 0.5 μm (19.69 μin) to 20 μm (787.4 μin), or from 1.0 μm (39.37 μin) to 20 μm (787.4 μin) or from 2.5 μm (98.43 μin) to 20 μm (787.4 μin). In embodiments, at least 50 wt. % (to at least 60, 70, 80, 90, 95, to 99 wt. %) of the active particulates are in a size range from 0.5 to 40 μm (19.69 to 1575 μin), or from 0.5 to 20 μm (19.69 to 787.4 μin), or from 1 μm (39.37 μin) to 20 μm (787.4 μin), or from 2.5 μm (98.43 μin) to 20 μm (787.4 μin). In embodiments, at least 90 wt. % of the active particulates are in a size range from 0.5 to 20 μm (19.69 to 787.4 μin). In embodiments, at least 90 wt. % of the active particulates are in a size range from 2.5 μm (98.43 μin) to 20 μm (787.4 μin). Particulates in this size range may be prepared, for example using grinding or spray drying techniques, which are known to the skilled practitioner. At least one active particulate is combined with the binder material to form the additive particles in a size range from 45 to 200 μm (1772 to 7874 μin), or from 45 to 120 μm (1772 to 4724 μin), or from 65 to 200 μm (2559 to 7874 μin), or from 65 to 120 μm (2559 to 4724 μin), or from 80 to 200 μm (3150 to 7874 μin), or from 80 to 120 μm (3150 to 4724 μin). In embodiments, at least 50 wt. % (or at least 60, 70, 80, 90, 95, or 99 wt. %) of the additive particles are in a size range from 45 to 200 μm (1772 to 7874 μin), or from 45 to 120 μm (1772 to 4724 μin), or from 65 to 200 μm (2559 to 7874 μin), or from 65 to 120 μm (2559 to 4724 μin), or from 80 to 200 μm (3150 to 7874 μin), or from 80 to 120 μm (3150 to 4724 μin). In embodiments, the additive particles comprise at least 50 wt. % (or at least 60, 70, 80, 90, 95, or 99 wt. %) of the at least one active particulate.

Fracture of the additive particles during use in an FCC results in a high proportion of entrained particles in the regenerator flue gas having a size larger than 0.5 μm (19.69 μin), or having a size range larger than 1 μm (39.37 μin), or having a size range larger than 2.5 μm (98.43 μin); particle fragments in this size range are more easily removed from the FCC regenerator flue gas than finer fragments produced by particle abrasion rather than by fracture.

### SOₓ Additive Particle Composition

In embodiments, the present invention involves a process for combusting a sulfur-containing material in the presence of an oxygen-containing gaseous fluid to form combustion products that contain sulfur oxides. The combustion process is conducted in the presence of additive particles that are SOₓ active, i.e., that are reactive with sulfur trioxide and/or sulfur dioxide and oxygen at elevated temperature to form at least one sulfur-containing solid, or that are converted at elevated temperature into a form that is reactive with sulfur trioxide or sulfur dioxide and oxygen.

In embodiments, the additive particles for use in a FCC are SOₓ additive particles. The SOₓ additive particles comprise at least one SOₓ active particulate, which is reactive with sulfur trioxide and/or sulfur dioxide and oxygen at elevated temperatures to form at least one sulfur-containing solid, or which is converted at elevated temperatures into a form that is reactive with sulfur trioxide or sulfur dioxide and oxygen. The SOₓ active particulates comprise at least one SOₓ active solid component. In embodiments, the SOₓ active particulates comprise at least 50 wt. % (or at least 60, 70, 80, 90, 95, or 99 wt. %) of at least one SOₓ active component. Oxides of the following metals, or spinels containing the metals: silver, aluminum, beryllium, cadmium, cobalt, chromium, copper, iron, gallium, germanium, mercury, indium, potassium, lithium, magnesium, manganese, molybdenum, nickel, tin, titanium, vanadium, tungsten, zinc, or mixtures thereof, are suitable as a SOₓ active solid component.

In some cases, the SOₓ active component comprises one or more bivalent metal oxides such as alkaline earth oxides. Of these, magnesia or an active source of magnesia that is converted into magnesia at elevated temperatures, is perhaps the most widely used. In embodiments, the SOₓ active component comprises complex inorganic oxide compositions such as MgAl₂O₄ spinel, mixtures of alumina and magnesium oxide, and mixtures of magnesium oxide and MgAl₂O₄ spinel. A metal-containing spinel is an exemplary metal oxide. Metal containing spinels are disclosed, for example, in U.S. Pat. No. 4,758,418, the entire disclosure of which is incorporated by reference for all purposes. Metal-containing spinels include the following: MnAl₂O₄, FeAl₂O₄, CoAl₂O₄, NiAl₂O₄, ZnAl₂O₄, MgTiMgO₄, FeMgFeO₄, FeTiFeO₄, ZnSnZnO₄, GaMgGaO₄, InMgInO₄, BeLi₂F₄, MoLi₂O₄, SnMg₂O₄, MgAl₂O₄, CuAl₂O₄, LiAl₅O₈, ZnK₂(CN)₄, CdK₂(CN)₄, HgK₂(CN)₄, ZnTi₂O₄, FeV₂O₄, MgCr₂O₄, MnCr₂O₄, FeCr₂O₄, CoCr₂O₄, NiCr₂O₄, ZnCr₂O₄, CdCr₂O₄, MnCr₂S₄, ZnCr₂S₄, CdCr₂S₄, TiMn₂O₄, MnFe₂O₄, FeFe₂O₄, CoFe₂O₄, NiFe₂O₄, CuFe₂O₄, ZnFe₂O₄, CdFe₂O₄, MgCo₂O₄, TiCo2O₄, CoCo₂O₄, ZnCo₂O₄, SnCo₂O₄, CoCo₂S₄, CuCo₂S₄, GeNi₂O₄, NiNi₂S₄, ZnGa₂O₄, WAg₂O₄, ZnSn₂O₄.

In embodiments, the SOₓ active particulates comprise alumina, magnesia or combinations thereof. In some such embodiments, the SOₓ active particulates comprise a magnesium-alumina spinel. In some such embodiments, the SOₓ active particulates comprise in the range from 50 to 99 wt. % of the magnesium-alumina spinel.

### Promoters

In embodiments, the activity of the SOₓ active particulate may be enhanced by addition of a promoter. In some such embodiments, the promoter comprises at least one a rare earth metal, or at least one noble metal, or at least one base metal, or combinations thereof. Suitable promoters include antimony, bismuth, cadmium, cerium, chromium, copper, dysoprosium, erbium, europium, gadolinium, germanium, gold, holmium, iridium, iron, lanthanum, lead, manganese, molybdenum, neodymium, nickel, niobium, osmium, palladium, platinum, praseodymium, promethium, rhenium, rhodium, ruthenium, samarium, scandium, selenium, silicon, silver, sulfur, tantalum, tellurium, terbium, tin, titanium, tungsten, thulium, vanadium, ytterbium, yttrium, or a mixture of two or more thereof. In an embodiment, the metal in the metallic oxidant is cerium, vanadium, copper, platinum, tungsten, or a mixture of two or more thereof. In another embodiment, the metal in the metallic oxidant is cerium and/or vanadium. In another embodiment, the metal in the metallic oxidant is copper. In another embodiment, the metal in the metallic oxidant is platinum. In embodiments, the SOx additive particles comprise in a range from 0.1 to 25 wt % promoter, calculated as the metal and based on the weight of the SOx additive particles. In embodiments, the SOₓ active component is promoted with rare earth metal, e.g. cerium and/or lanthanum, in the range from 1 to 25 wt. %, or in the range from 2 to 15 wt. %, calculated as the metal and based on the weight of the SOₓ active component. In embodiments, the SOₓ active component is promoted with vanadium, in the range from 0.1 to 10 wt. %, or in the range from 0.5 from 5 wt. % vanadium, calculated as the metal and based on the weight of the SOₓ active component.

### Active Oxide

### Magnesium Aluminate Spinel

In one embodiment, the SOₓ active particulates comprise a magnesium aluminate spinel. Magnesium aluminate spinels are described, for example, in U.S. Pat. No. 4,758,418, the entire disclosure of which is incorporated herein by reference for all purposes. The magnesium aluminate spinel suitable for use in the present invention can be prepared, for example, by reacting, in an aqueous medium, a water-soluble magnesium inorganic salt and a water-soluble aluminum salt in which the aluminum is present in the anion. Suitable salts are exemplified by the strongly acidic magnesium salts such as the chloride, nitrate or sulfate and the water soluble alkali metal aluminates. The magnesium and aluminate salts are dissolved in an aqueous medium and a spinel precursor is precipitated through neutralization of the aluminate by the acidic magnesium salt. Often, the precipitate is washed free of extraneous ions before being further processed.

The precipitate can be dried and calcined to yield the magnesium aluminate spinel. Drying and calcination may take place simultaneously. Alternatively, the drying may take place at a temperature below which water or hydration is removed from the spinel precursor. Thus, this drying may occur at temperatures below about 250° C. (about 482 degree Fahrenheit), or from about 100° C. (about 212 degree Fahrenheit) to about 225° C. (about 437 degree Fahrenheit). Suitable calcination temperatures are exemplified by temperatures ranging from about 425° C. (about 797 degree Fahrenheit) to about 1100° C. (about 2012 degree Fahrenheit) or more. Calcination of the spinel precursor may take place in a period of time of at least about one half hour and often in a period of time ranging from about 1 hour to about 10 hours.

An exemplary process for producing the presently useful magnesium aluminate spinel includes mixing a solution of a soluble acid salt of divalent magnesium with a solution of an alkali metal aluminate; separating and washing the resulting precipitate; exchanging the washed precipitate with a solution of an ammonium compound to decrease the alkali metal content; followed by washing, drying, forming and calcination steps. The metal spinel-based composition may be formed into particles of any desired shape such as pills, cake, extrudates, powders, granules, spheres, and the like using conventional methods. In embodiments, the particulates are in a size range from 0.5 μm (19.69 μin) to 40 μm (1575 μin). In some such embodiments, the SOₓ active particulates are in a size range from 0.5 μm (19.69 μin) to 20 μm (787.4 μin), or from 1 μm (39.37 μin) to 20 μm (787.4 μin), or from 2.5 μm (98.43 μin) to 20 μm (787.4 μin).

Substantially non-interfering proportions of other well known refractory material, e.g., inorganic oxides such as silica, zirconia, thoria and the like may be included in the particulates. Free magnesia and/or alumina (i.e., apart from the alkaline earth metal containing spinel) also may be included in the SOₓ active particulates, e.g., using conventional techniques. For example, the discrete entities may include about 0.1% to about 25% by weight of free magnesia (calculated as MgO). The phrase “substantially non-interfering” refers to amounts of other material which do not have a substantial deleterious effect on the present catalyst system or hydrocarbon conversion process. The inclusion of materials such as silica, zirconia, thoria and the like into the SOₓ active particulates may act to improve one or more of their functions.

Cerium or other suitable rare earth or rare earth mixtures may be associated with the spinel using any suitable technique or combination of techniques; for example, impregnation, coprecipitation, ion-exchange and the like. Impregnation may be carried out by contacting the spinel with a solution, such a rare earth aqueous solution; for example, a solution containing cerium ions or a mixture of rare earth cations containing a substantial amount (for example, at least 40%) of cerium ions. Water-soluble sources of rare earth typically include nitrate and chloride. In embodiments, the solutions have a concentration of rare earth in the range from 3 to 30% by weight. Generally, sufficient rare earth salt is added to incorporate about 0.05 to 25 wt. % in the particulates. In embodiments, about 0.1 to 15% rare earth, or about 1.0 to 15% rare earth, by weight, calculated as elemental metal, are incorporated in the particulates.

### Rare Earth Magnesium Alumina Spinel

In an embodiment, the SOₓ active particulates comprise a rare earth/magnesia/alumina spinel. Using bastnaesite as a rare earth source, in combination with magnesium aluminate spinels is disclosed, for example, in U.S. Pat. No. 5,545,604, the entire disclosure of which is incorporated herein by reference for all purposes. An exemplary method for making this spinel includes: (1) suspending or dispersing alumina in a liquid medium provided with between about 0.5 and about 10.0 milliequivalents of a mono-protonic acid per gram of alumina to produce an alumina sol; (2) mixing magnesium compound such as magnesium acetate with the alumina sol and thereby creating a magnesium/alumina gel; (3) mixing bastnaesite with the magnesium/alumina gel and thereby creating a bastnaesite/magnesium/alumina total reaction composition; (4) spray drying the bastnaesite/magnesium/alumina total reaction composition to produce a solid material; and (5) calcining the solid material to produce a bastnaesite/magnesium oxide/alumina compound.

In another embodiment, a process for preparing the bastnaesite/magnesia/alumina spinel includes: (1) dispersing alumina in a water solution containing between about 3.0 and about 5.0 milliequivalents of a mono-protonic acid per gram of alumina, (2) mixing a magnesium-containing compound, (e.g., magnesium acetate, magnesium nitrate) and a cerium-containing compound, (e.g., cerium nitrate, cerium acetate) and a vanadium-containing compound (e.g., ammonium meta-vanadate), with the alumina dispersion to form a gel, (3) adding bastnaesite to the gel, (4) spray drying the gel, and (5) calcining the product of the spray drying. In embodiments, the particulates are in a size range from 0.5 μm (19.69 μin) to 40 μm (1575 μin). In some such embodiments, the SOₓ active bastnaesite/magnesia/alumina spinel particulates are in a size range from 0.5 μm (19.69 μin) to 20 μm (787.4 μin), or from 1 μm (39.37 μin) to 20 μm (787.4 μin), or from 2.5 μm (98.43 μin) to 20 μm (787.4 μin). Larger particulates recovered from spray drying may be further reduced in size as desired.

### Hydrotalcite

In embodiments, the SOₓ active particulates comprise hydrotalcite. Hydrotalcite like compounds, characterized by structures having positively charged layers that are separated by interstitial anions and/or water molecules, have been found to have SOₓ activity. Hydrotalcite like compounds and their preparation as SOₓ active particulates is described, for example, in U.S. Pat. No. 7,347,929, the entire disclosure of which is incorporated herein for all purposes.

Hydrotalcite is a layered double hydroxide of magnesium and aluminum. The general stoichiometric formula for hydrotalcite is Mg₆Al₂(CO₃)(OH)₁₆.4(H₂O); variations from this stoichiometry are also suitable for the present process. Hydrotalcite is generally not stable under elevated temperatures; stable combinations may be prepared by incorporating hydrotalcite with magnesium aluminate spinel.

In an embodiment, the SOₓ active particulates comprise mixed metal oxide compounds, also referred to herein as precursors of hydrotalcite like compounds, produced, for example, by the following process: (a) reacting an aqueous mixture comprising at least one divalent metal compound and at least one trivalent metal compound to produce a mixed metal oxide compound in the form of an aqueous slurry; (b) optionally heat treating the mixed metal oxide compound from step (a) at a temperature up to about 225° Celsius (about 437 degree Fahrenheit) to produce a heat-treated mixed metal oxide compound in the form of an aqueous slurry; (c) drying the heat-treated compound from step (b) to produce one or more shaped bodies of the mixed metal oxide compound; and, optionally, (d) heat treating the compound from step (c) at a temperature of about 300° Celsius (about 572 degree Fahrenheit) or higher to produce one or more calcined shaped bodies of a mixed metal oxide compound.

In some embodiments, the heat treating in step (d) is optional. In other embodiments of the invention, step (a) can result in the production of minor amounts (e.g., 15% or less; 10% or less; 5% or less; 1% or less) of hydrotalcite like compounds. In other embodiments, step (a) produces substantially no hydrotalcite like compounds. Steps (a)-(d) can be conducted in a continuous and/or batch wise manner. The terms “aqueous slurry” and “slurry” include, for example, sol solutions, gels and pastes. In the methods of making the shaped bodies of the mixed metal oxide compounds of the invention, a solvent can optionally be added to the slurry during the heat treatment of step (b). The solvent can be, for example, acetic acid, propionic acid, formic acid, butyric acid, valeric acid, nitric acid, ammonium hydroxide, water, and the like. In one embodiment, the solvent is acetic acid.

In the above method, prior to step (a), the divalent metal compound can be prepared in the form of a slurry, and the trivalent metal compound can be prepared in the form of a slurry. The divalent metal compound and the trivalent metal compound can be separately prepared in the form of a slurry, and then mixed together; or a mixture containing the divalent metal compound and the trivalent metal compound can be prepared by simultaneously or concurrently mixing the compounds together in the form of a slurry.

In one embodiment, the aqueous mixture in step (a) of the method of preparing mixed metal oxide compounds can further comprise one or more other metal components such as metals of antimony, bismuth, cadmium, cerium, chromium, cobalt, copper, dysoprosium, erbium, europium, gadolinium, germanium, gold, holmium, iridium, iron, lanthanum, lead, manganese, molybdenum, neodymium, nickel, niobium, osmium, palladium, platinum, praseodymium, promethium, rhenium, rhodium, ruthenium, samarium, scandium, selenium, silicon, silver, sulfur, tantalum, tellurium, terbium, tin, titanium, tungsten, thulium, vanadium, ytterbium, yttrium, zinc, or a mixture of two or more thereof. The metals can be in an elemental state and/or can be in the form of metal oxides, metal sulfides, metal halides, or mixtures of two or more thereof. In one embodiment, the aqueous reaction mixture further comprises copper (e.g., CuO), cobalt (e.g., CoO), vanadium (e.g., V₂O₅), titanium (e.g., TiO₂), lanthanum (e.g., La₂O₃), cerium (e.g., CeO₂), tungsten, or a mixture of two or more thereof. In another embodiment, the aqueous reaction mixture further comprises copper (e.g., CuO), cobalt (e.g., CoO), vanadium (e.g., V₂O₅), cerium (e.g., CeO₂), or a mixture of two or more thereof. The one or more metal components (or oxides, sulfides, and/or halides thereof) can be present in the aqueous reaction mixture in an amount up to about 40% by weight; or from about 1% to about 25% by weight; or from about 2% to about 20% by weight, calculated as the oxide equivalent. The one or more other metal components can be added to the aqueous reaction mixture at the same time as the at least one divalent metal compound and the at least one trivalent metal compound are being mixed together to form the aqueous slurry.

Step (b) of heat treating the aqueous slurry in the above method can be conducted by heat treating the aqueous slurry at a temperature of about 50° Celsius (about 122 degree Fahrenheit) to less than 225° Celsius (437 degree Fahrenheit); at a temperature of about 60° Celsius (about 140 degree Fahrenheit) to about 200° Celsius (about 392 degree Fahrenheit); at a temperature of about 70° Celsius (about 158 degree Fahrenheit) to about 150° Celsius (about 302 degree Fahrenheit); at a temperature of about 75° Celsius (about 167 degree Fahrenheit) to about 100° Celsius (about 212 degree Fahrenheit); or at a temperature of about 80° Celsius (about 176 degree Fahrenheit) to about 85° Celsius (about 185 degree Fahrenheit). The low temperature heat treating step can be conducted for about 10 minutes to about 24 hours or more. The low temperature heat treatment is generally conducted in air or an inert atmosphere, and at atmospheric pressures. In one embodiment, the step of low temperature heat treatment is accomplished using steam injection, jacketing, heat coils, and/or autoclave. The low temperature heat treatment does not result in a dry compound, but instead is in the form of a heat-treated, aqueous slurry.

In embodiments, hydrotalcite is prepared in SOₓ active particulates that are in a size range from 0.5 μm (19.69 μin) to 40 μm (1575 μin). In some such embodiments, the SOₓ active particulates are in a size range from 0.5 μm (19.69 μin) to 20 μm (787.4 μin), or from 1 μm (39.37 μin) to 20 μm (787.4 μin), or from 2.5 μm (98.43 μin) to 20 μm (787.4 μin).

### Binder

In embodiments, the SOₓ active particulates further comprise a binder. There are many different binders that are useful in forming the SOₓ active particulates. Non-limiting examples of binders that are useful alone or in combination include various types of alumina, silica and magnesia. Exemplary binders include alumina or an active source of alumina. One active source of alumina is aluminum chlorohydrate. The inorganic oxide sol acts like glue binding the SOₓ active particulates and other materials such as the matrix material together, particularly after thermal treatment. Upon heating, the inorganic oxide sol, preferably having a low viscosity, is converted into an inorganic oxide matrix component. For example, an alumina sol will convert to an aluminum oxide matrix following heat treatment.

Aluminum chlorohydrate, a hydroxylated aluminum based sol containing a chloride counter ion, has the general formula of AlₘOₙ.(OH)₀Clₚ.x(H₂O) wherein m is 1 to 20, n is 1 to 8, o is 5 to 40, p is 2 to 15, and x is 0 to 30. In one embodiment, the binder is Al₁₃0₄(OH)₂₄CL₇.12(H₂O) as is described in G. M. Wolterman, et al., Stud. Surf. Sci. and Catal., 76, pages 105-144 (1993), which is herein incorporated by reference. In another embodiment, one or more binders are combined with one or more other non-limiting examples of alumina materials such as aluminum oxyhydroxide, γ-alumina, boehmite, diaspore, and transitional aluminas such as α-alumina, β-alumina, γ-alumina, δ-alumina, ε-alumina, κ-alumina, and ρ-alumina, aluminum trihydroxide, such as gibbsite, bayerite, nordstrandite, doyelite, and mixtures thereof. In another embodiment, the binders are alumina sols, predominantly comprising aluminum oxide, optionally including some silicon. In yet another embodiment, the binders are peptized alumina made by treating alumina hydrates such as pseudobohemite, with an acid, preferably an acid that does not contain a halogen, to prepare sols or aluminum ion solutions.

In embodiments, the SOₓ active particulates comprise up to 50 wt. % binder. In some such embodiments, the SOₓ active particulates comprise up to 50 wt. %, or up to 40 wt. %, or up to 30 wt. %, or up to 20 wt. %, or up to 10 wt. %, or up to 5 wt. %, or up to 1 wt. % binder. In some such embodiments, the SOₓ active particulates comprise in the range from 0.1 wt. % to 50 wt. % binder.

### SOₓ Additive Particles

The SOₓ additive particles comprise at least one SOₓ active particulate and a binder material. In embodiments, the SOₓ additive particles undergo breakage mechanisms during use in the FCC reaction system, such that at least some of the particle fragments generated from the breakage mechanisms have a particle size of greater than 0.5 μm (19.69 μin). In some embodiments, at least 50 wt. % the particle fragments from SOₓ additive particle breakage have a particle size of greater than 0.5 μm (19.69 μin), or greater than 1 μm (39.37 μin), or greater than 2.5 μm (98.43 μin).

There are many different binder materials that are useful in forming the SOₓ active particulates. Non-limiting examples include, for example, various types of hydrated alumina, silicas, and/or other inorganic oxide sol and combinations thereof. Exemplary binders include alumina or an active source of alumina. One active source of alumina is aluminum chlorohydrate. The inorganic oxide sol acts like glue binding the SOₓ active particulates and other materials such as the matrix material together, particularly after thermal treatment. Upon heating, the inorganic oxide sol, preferably having a low viscosity, is converted into an inorganic oxide matrix component. For example, an alumina sol will convert to an aluminum oxide matrix following heat treatment.

Aluminum chlorohydrate, a hydroxylated aluminum based sol containing a chloride counter ion, has the general formula of AlₘOₙ.(OH)₀Clₚ.x(H₂O) wherein m is 1 to 20, n is 1 to 8, o is 5 to 40, p is 2 to 15, and x is 0 to 30. In one embodiment, the binder is Al₁₃0₄(OH)₂₄CL₇.12(H₂O) as is described in G. M. Wolterman, et al., Stud. Surf. Sci. and Catal., 76, pages 105-144 (1993), which is herein incorporated by reference. In another embodiment, one or more binders are combined with one or more other non-limiting examples of alumina materials such as aluminum oxyhydroxide, γ-alumina, boehmite, diaspore, and transitional aluminas such as α-alumina, β-alumina, γ-alumina, δ-alumina, ε-alumina, κ-alumina, and ρ-alumina, aluminum trihydroxide, such as gibbsite, bayerite, nordstrandite, doyelite, and mixtures thereof. In another embodiment, the binders are alumina sols, predominantly comprising aluminum oxide, optionally including some silicon. In yet another embodiment, the binders are peptized alumina made by treating alumina hydrates such as pseudobohemite, with an acid, preferably an acid that does not contain a halogen, to prepare sols or aluminum ion solutions.

In embodiments, the SOₓ additive comprises up to 50 wt. % binder. In some such embodiments, the SOₓ additive comprises up to 50 wt. %, or up to 40 wt. %, or up to 30 wt. %, or up to 20 wt. %, or up to 10 wt. %, or up to 5 wt. %, or up to 1 wt. % binder. In some such embodiments, the SOₓ additive comprises in the range from 0.1 wt. % to 50 wt. % binder.

### Matrix Material

In embodiments, the SOₓ additive particles further comprise a matrix material. Matrix materials are typically effective in providing additional SOₓ additive capacity, reducing overall catalyst cost, act as thermal sinks assisting in shielding heat from the catalyst composition for example during regeneration, densifying the catalyst composition, increasing catalyst strength such as crush strength and attrition resistance, and to control the rate of conversion in a particular process. An exemplary matrix material includes one or more of spinels, magnesia, magnesium acetates, magnesium nitrates, magnesium chlorides, magnesium hydroxides, magnesium carbonates, magnesium formates, magnesium aluminates, hydrous magnesium silicates, magnesium silicates, magnesium calcium silicates, aluminum silicates, boria, calcium silicates, alumina, aluminum titanates, zinc titanates, aluminum zirconates, calcium oxides, calcium aluminates, aluminum nitrohydrates, aluminum hydroxide compounds, aluminum-containing metal oxide compounds, aluminum chlorohydrates, silicas, silicon-containing compounds other than silicas, silica/aluminas, alumina, titania, zirconia, clays (e.g., halloysite, rectorite, hectorite, montmorillinite, synthetic montmorillinite, sepiolite, activated sepeolite, kaolin, kieselguhr, celite, bastnasite), clay phosphate materials, zeolites (e.g., ZSM-5), and the like. The matrix material can comprise one, two, three, four or more of the materials described above. In one embodiment, the matrix material is a spinel, magnesium acetate, magnesium nitrate, magnesium chloride, magnesium hydroxide, magnesium carbonate, magnesium formate, magnesium aluminate, aluminum titanate, zinc titanate, aluminum zirconate, calcium oxide, calcium aluminate, aluminum nitrohydrate, aluminum hydroxide compound, aluminum-containing metal oxide compound, aluminum chlorohydrate, titania, zirconia, or a mixture of two or more thereof. In one embodiment, the matrix material has SOₓ sorption activity at elevated temperatures. In one embodiment, the matrix material is alumina or a mixture of alumina and silica or a kaolin clay.

In embodiments, the SOₓ additive particles comprise up to 50 wt. % (or less than 40, 30, 20, 10, 5, or 1 wt. %) of the matrix material. Exemplary SOₓ additive particles comprise in the range from 0.1 wt. % to 50 wt. % of the matrix material. Magnesium, including any suitable magnesium compound, may be included as a matrix material in the SOₓ additive particles.

### Forming the SOₓ Additive Particles

Preparation of the SOₓ additive particles includes preparing the SOₓ active particulates, which are then bound into additive particles with the binder and, optionally, with the matrix material. In general, the SOₓ additive particles comprise at least 10 vol. % particulates. In embodiments, the SOₓ additive particles comprise greater than 35 vol. %, or greater than 45 vol. %, or greater than 55 vol. %, or greater than 65 vol. %, or greater than 75 vol. %, or greater than 85 vol. %, or greater than 95 vol. % SOₓ active particulates.

In embodiments, the process for preparing SOₓ additive particles comprises forming an oxide composition; forming SOₓ active particulates comprising at least a portion of the oxide composition; and forming SOₓ additive particles comprising at least a portion of the SOₓ active particulates.

An exemplary oxide composition comprises alumina or an active source of alumina that is converted to alumina at elevated temperatures and magnesia or an active source of magnesia that is converted to magnesia at elevated temperatures. Another exemplary oxide composition comprises a spinel or a spinel precursor that is converted to a spinel during preparation or during employment at elevated temperatures. The oxide composition, optionally in combination with one or more binder materials, is composited into SOₓ active particulates, at least a portion of which are in a size range from 0.5 μm (19.69 μin) to 40 μm (1575 μin).

Suitable particulates may be prepared, for example, by grinding or by spray drying to form finely divided material into self-supporting particulates of the desired size. In one embodiment, a slurry of the oxide composition and binder in water is mixed or milled to achieve a sufficiently uniform slurry of sub-particles, that are then fed to a forming unit, such as a spray dryer, that produces the SOₓ active particulates. Typically, the forming unit is maintained at a temperature sufficient to remove most of the liquid from the slurry, and from the resulting particulates.

When a spray drier is used as the forming unit, typically, the slurry of the oxide composition and binder is co-fed to the spray drying volume with a drying gas with an average inlet temperature ranging from 200° Celsius (392 degree Fahrenheit) to 550° Celsius (1022 degree Fahrenheit), and a combined outlet temperature ranging from 100° Celsius (212 degree Fahrenheit) to about 225° Celsius (about 437 degree Fahrenheit).

In the preparation of SOₓ additive particles, SOₓ active particulates are composited into SOₓ additive particles, at least a portion of which are in a size range from 45 μm (1772 μin) to 200 μm (7874 μin). Suitable additive particles may be prepared, for example, by grinding or by spray drying to form finely divided material into self-supporting particles of the desired size. In one embodiment, a slurry of the active particulates, a binder material, and optionally a matrix material, in water is mixed or milled to achieve a sufficiently uniform slurry of sub-particles, that are then fed to a forming unit, such as a spray dryer, that produces the SOₓ additive particles. Typically, the forming unit is maintained at a temperature sufficient to remove most of the liquid from the slurry, and from the resulting particulates.

The SOₓ additive particles used in embodiments of the present invention is included in the particle solids, other than catalyst particles, which are physically suitable for circulation in the cracking system. The SOₓ additive can be formed into particles of suitable size for circulation with FCC catalyst in an FCC system, such as by spray-drying and crushing larger particles.

An exemplary process for preparing SOₓ additive particles for mitigating gas phase SOₓ includes: blending a SOₓ active component with at least one source of alumina to form a blend; forming at least a portion of the blend into particulates; drying and calcining at least a portion of the particulates to form SOₓ active particulates; forming a mixture of at least a portion of the calcined particulates and an active source of a binder; forming at least a portion of the mixture into particles; and drying and calcining at least a portion of the particles to form SOₓ additive particles.

A further exemplary process for preparing SOₓ additive particles includes: forming a SOₓ active component into particulates; drying and calcining at least a portion of the particulates to form SOₓ active particulates; forming a mixture of at least a portion of the calcined particulates and an active source of a binder; forming at least a portion of the mixture into particles; and drying and calcining at least a portion of the particles to form SOₓ additive particles.

### FCC Catalyst

### FCC Catalyst Composition

In embodiments, the additive particles for use in a fluid catalytic reactor are cracking particles comprising active cracking particulates and a binder material. In some such embodiments, the additive particles are reactive with hydrocarbon feeds at fluid catalytic cracking conditions to form cracked hydrocarbon fluid products.

### Cracking Catalyst

In embodiments, the active cracking particulates comprise cracking catalysts. The cracking catalysts with which the present invention finds utility are those which include a zeolitic or molecular sieve component. In embodiments, the cracking catalysts include a zeolite component associated with a non-crystalline silica-alumina or silica-containing clay matrix. Non-zeolite-type catalysts including silica clays, such as amorphous silica-aluminas and silica-magnesia clays, are also within the scope of the invention. In embodiments, the cracking components are the acidic, zeolitic crystalline aluminosilicates such as X-type and Y-type faujasites, in the hydrogen form, the rare earth form, or other equally stable form. Exemplary zeolites are selected from a group consisting of rare earth-exchanged X or Y, hydrogen Y, ultrastable Y, or ZSM-5. The particulate solids inventory used in a system in an embodiment of the invention includes at least 75 wt. % of particles containing from 5 to 30 wt. % of a zeolitic crystalline aluminosilicate. On the other hand, acidic, non-crystalline catalyst such as silica-aluminas can be used. For example, it may be desirable, for economic reasons, to use a mixture of cracking catalysts, one of which contains a zeolitic cracking component, while the other contains only relatively inexpensive amorphous silica-alumina, e.g., in systems where catalyst must be added frequently as a result of high feed metal levels or the like.

A zeolite-containing cracking catalyst component may be formed by treatment of kaolin clay, as by slurrying the clay, sizing and spray drying, followed by treatment with caustic at elevated temperature for a time sufficient to generate a fraction of the desired zeolite in the treated clay, with the clay acting as the matrix. The zeolite component in the particles can then be converted to the ammonium and/or rare earth form by ion-exchange, if desired. Of course, there is usually still substantial non-crystalline silica content in catalysts manufactured in this manner. The zeolite can also be manufactured separately and added to the desired matrix or binder material. Conventional binders such as clays, acid-treated clays, and synthetic silica-alumina cogels can be used as the binder, or as a component of the binder.

### Binder Material

There are many different binder materials that are useful in forming the SOₓ active particulates. Non-limiting examples include, for example, various types of hydrated alumina, silicas, and/or other inorganic oxide sol and combinations thereof. Exemplary binders include alumina or an active source of alumina. One active source of alumina is aluminum chlorohydrate. The inorganic oxide sol acts like glue binding the SOₓ active particulates and other materials such as the matrix material together, particularly after thermal treatment. Upon heating, the inorganic oxide sol, preferably having a low viscosity, is converted into an inorganic oxide matrix component. For example, an alumina sol will convert to an aluminum oxide matrix following heat treatment.

Aluminum chlorohydrate, a hydroxylated aluminum based sol containing a chloride counter ion, has the general formula of AlₘOₙ.(OH)₀Clₚ.x(H₂O) wherein m is 1 to 20, n is 1 to 8, o is 5 to 40, p is 2 to 15, and x is 0 to 30. In one embodiment, the binder is Al₁₃0₄(OH)₂₄CL₇.12(H₂O) as is described in G. M. Wolterman, et al., Stud. Surf. Sci. and Catal., 76, pages 105-144 (1993), which is herein incorporated by reference. In another embodiment, one or more binders are combined with one or more other non-limiting examples of alumina materials such as aluminum oxyhydroxide, γ-alumina, boehmite, diaspore, and transitional aluminas such as α-alumina, β-alumina, γ-alumina, δ-alumina, ε-alumina, κ-alumina, and ρ-alumina, aluminum trihydroxide, such as gibbsite, bayerite, nordstrandite, doyelite, and mixtures thereof. In another embodiment, the binders are alumina sols, predominantly comprising aluminum oxide, optionally including some silicon. In yet another embodiment, the binders are peptized alumina made by treating alumina hydrates such as pseudobohemite, with an acid, preferably an acid that does not contain a halogen, to prepare sols or aluminum ion solutions.

In embodiments, the SOₓ additive comprises up to 50 wt. % binder. In some such embodiments, the SOₓ additive comprises up to 50 wt. %, or up to 40 wt. %, or up to 30 wt. %, or up to 20 wt. %, or up to 10 wt. %, or up to 5 wt. %, or up to 1 wt. % binder. In some such embodiments, the SOₓ additive comprises in the range from 0.1 wt. % to 50 wt. % binder.

### Forming the Cracking Catalyst

Suitable active particulates, containing a catalyst, such as a molecular sieve or a zeolite, having catalytic activity for the cracking of hydrocarbon feeds or petroleum-based materials may be prepared, for example, by grinding or by spray drying to form finely divided material into particulates of the desired size. In one embodiment, a slurry containing the catalyst and a binder in water is mixed or milled to achieve a sufficiently uniform slurry of sub-particles of the active particulates that are then fed to a forming unit, such as a spray dryer, that produces the active particulates. Typically, the forming unit is maintained at a temperature sufficient to remove most of the liquid from the slurry, and from the resulting active particulates.

When a spray drier is used as the forming unit, typically, the slurry of the molecular sieve composition and binder, and optionally a matrix material, is co-fed to the spray drying volume with a drying gas with an average inlet temperature ranging from 200° Celsius (392 degree Fahrenheit) to 550° Celsius (1022 degree Fahrenheit), and a combined outlet temperature ranging from 100° Celsius (212 degree Fahrenheit) to about 225° Celsius (about 437 degree Fahrenheit). As prepared, the active cracking particulates generally are in a size range from 0.5 μm (19.69 μin) to 40 μm (1575 μin). In embodiments, the active cracking particulates are in a size range from 0.5 μm (19.69 μin) to 20 μm (787.4 μin), or from 1 μm (39.37 μin) to 20 μm (787.4 μin), or from 2.5 μm (98.43 μin) to 20 μm (787.4 μin). In embodiments, at least 50 wt. % (to at least 60, 70, 80, 90, 95, to 99 wt. %) of the active cracking particulates are in a size range from 0.5 μm (19.69 μin) to 40 μm (1575 μin), or from 0.5 to 20 μm (19.69 to 787.4 μin), or from 1 μm (39.37 μin) to 20 μm (787.4 μin), or from 2.5 to 20 μm (98.43 to 787.4 μin). In embodiments, at least 90 wt. % of the active cracking particulates are in a size range from 0.5 to 20 μm (19.69 to 787.4 μin).

In the preparation of additive particles having the form and function of catalytic particles, the active particulates containing the catalyst are composited into catalytic particles, at least a portion of which are in a size range from 45 μm (1772 μin) to 200 μm (7874 μin). Suitable additive particles may be prepared, for example, by grinding or by spray drying to form the active particulates into self-supporting particles of the desired size. In one embodiment, a slurry of the active particulates, a binder material, and optionally a matrix material, in water is mixed or milled to achieve a sufficiently uniform slurry of sub-particles, that are then fed to a forming unit, such as a spray dryer, that produces the SOₓ additive particles. Typically, the forming unit is maintained at a temperature sufficient to remove most of the liquid from the slurry, and from the resulting particulates. In an embodiment, the catalytic particles are in a size range from 45 to 200 μm (1772 to 7874 μin), or from 45 to 120 μm (1772 to 4724 μin), or from 65 to 200 μm (2559 to 7874 μin), or from 65 to 120 μm (2559 to 4724 μin), or from 80 to 200 μm (3150 to 7874 μin), or from 80 to 120 μm (3150 to 4724 μin). In embodiments, at least 50 wt. % (or at least 60, 70, 80, 90, 95, or 99 wt. %) of the catalytic particles are in a size range from 45 to 200 μm (1772 to 7874 μin), or from 45 to 120 μm (1772 to 4724 μin), or from 65 to 200 μm (2559 to 7874 μin), or from 65 to 120 μm (2559 to 4724 μin), or from 80 to 200 μm (3150 to 7874 μin), or from 80 to 120 μm (3150 to 4724 μin). In embodiments, the catalytic particles comprise at least 50 wt. % (or at least 60, 70, 80, 90, 95, or 99 wt. %) of the at least one active particulate.

### FCC Reactor

The FCC unit typically comprises a reactor for converting a petroleum feedstock to lower molecular weight products by contacting the feedstock with a fluid catalytic cracking catalyst. The FCC catalyst, which is deactivated by coke deposition during the cracking reaction, is passed to a regenerator in the FCC unit to combust the coke and to regenerate the cracking catalyst. The catalyst inventory in the FCC unit generally comprises the FCC catalyst and a SOₓ additive, which is provided to adsorb sulfur oxides that are generated during coke combustion. In the absence of the SOₓ additive, sulfur oxides produced in the regenerator are vented with the regenerator flue gas, where it is removed by a separate scrubbing process to prevent escape into the atmosphere. With the SOₓ additive present, a portion of the sulfur oxides are absorbed by the SOₓ additive and returned to the FCC reactor during the cycling of the catalyst inventory in the FCC unit. In the reactor, adsorbed sulfur oxides are reduced to volatile sulfur species, such as hydrogen sulfide (H₂S), which is captured in the refinery sour gas recovery system.

### FCC Feed

The same hydrocarbon feeds normally processed in commercial FCC systems may be processed in a cracking system employing the present invention. Suitable hydrocarbon feeds include, for example, petroleum distillates or residuals, either virgin or partially refined. Synthetic feeds such as coal oils and shale oils are also suitable. Suitable hydrocarbon feeds normally boil in the range from about 200° Celsius (about 392 degree Fahrenheit) to 600° Celsius (1112 degree Fahrenheit) or higher. A suitable feed may include recycled hydrocarbons which have already been subjected to cracking

### FCC Reaction Conditions

Cracking conditions employed in the cracking or conversion step in an FCC system are frequently provided in part by pre-heating and heat-exchanging hydrocarbon feeds to bring them to a temperature of about 315° Celsius (about 599 degree Fahrenheit) to 400° Celsius (752 degree Fahrenheit) before introducing them into the cracking zone; however, pre-heating of the feed is not essential. The stream of hydrocarbon feed is contacted with fluidized catalyst particles in the cracking zone, or reactor, usually at a temperature of about 425° Celsius (797 degree Fahrenheit) to 700° Celsius (1292 degree Fahrenheit). Cracking conditions usually include a catalyst/hydrocarbon weight ratio of about 3-10. A hydrocarbon weight space velocity in the cracking zone of about 5-50 per hour is generally used. The average amount of coke contained in the catalyst after contact with the hydrocarbons in the cracking zone, when the catalyst is passed to the regenerator, may be between about 0.5 wt. % and about 2.5 wt. %, depending in part on the carbon content of regenerated catalyst in the particular system, as well as, the heat balance of the particular system.

The catalyst regeneration zone used in an FCC system employing an embodiment of the present invention may be of conventional design. Generally, fluid catalytic cracking regenerator conditions include a temperature in the range from 538° Celsius (1000 degree Fahrenheit) to 816° Celsius (1501 degree Fahrenheit), a pressure of 20 psig or higher, and in the presence of a gaseous fluid comprising at least 0.1 vol. % oxygen. The gaseous atmosphere within the regeneration zone normally includes a mixture of gases in concentrations which vary according to the locus within the regenerator. The concentrations of gases also vary according to the coke concentration on catalyst particles entering the regenerator and according to the amount of molecular oxygen and steam passed into the regenerator. Generally, the gaseous atmosphere in a regenerator contains 5-25% steam, varying amounts of oxygen, carbon monoxide, carbon dioxide and nitrogen. The present invention is applicable in cases in which an oxygen-containing and nitrogen-containing gaseous fluid, such as air, is employed for combustion of coke in the catalyst regenerator. As will be appreciated by those skilled in the art, air can be employed to provide the oxygen utilized for combustion in FCC regenerators. Sulfur oxides are removed from the flue gas in a catalyst regeneration zone by reacting sulfur oxides, e.g., sulfur trioxide, with a SOₓ additive.

### SOₓ Mitigation Process

In carrying out the invention, SOₓ additive particles are introduced into a cracking system and circulated in physical mixture with cracking catalyst. Both FCC catalyst and SOₓ additive particles have near spherical forms with an average size between 45-200 μm (1772-7874 μin) to give a desirable fluidization property in FCC units. FCC catalysts generally contain an active porous oxide component, such as silicate or aluminosilicate zeolite, and an inert matrix component of a clay or clay-type composition. The matrix component serves as a catalyst support and a binder for the active component, providing physical strength against attrition. The amount of separate, SOₓ additive particles employed in the particulate solids inventory is preferably 25 wt. %, or less, of the total particulate solids inventory circulating in the cracking system. In embodiments, the total inventory of particles circulated in the cracking system comprises between 1.0 and 25 wt. % of the SOₓ additive particles. In embodiments, the size, shape and density of separate, SOₓ additive particles, circulated in admixture with catalyst particles is selected such that the SOₓ additive particles circulate in substantially the same manner as conventional catalyst particles in the particular cracking system, e.g., beads are used in a moving-bed, bead-catalyst unit, whereas 45-200 micron size particles are quite suitable in an FCC unit. The SOₓ additive particles are reactive with sulfur trioxide or sulfur dioxide and oxygen at elevated temperatures to form at least one sulfur-containing solid. In this way, sulfur oxides are removed from the regenerator atmosphere and are not discharged from the regenerator in the flue gas.

During circulation in the FCC unit, the catalyst and SOₓ additive particles are reduced in size due to fracturing and attrition. Resulting particle fragments having a size of less than about 40 μm (about 1575 μin), and often with a size of less than 20 μm (787.4 μin), are carried along with flue gas from the catalyst regeneration unit. Flue gas leaving the circulating catalyst in the FCC regenerator first pass through one or more cyclones, which remove entrained particles from the flue gas. The flue gas then passes through one or more electrostatic precipitator units, which remove entrained particles with a particle size of greater than about 0.5 μm (about 19.69 μin). At least a portion of the “fines”, i.e. particles with a size of less than 0.5 μm (19.69 μin), pass through the ESP and are vented to the atmosphere along with the flue gas.

In embodiments, the catalytic cracking process comprises circulating a mixture of cracking catalyst and SOₓ additive within a catalytic cracking unit which includes a catalyst regeneration unit, passing air through the catalyst regeneration unit, and producing a flue gas stream that contains particulate fragments, including catalyst fragments and SOₓ additive fragments, wherein at least 50 wt. % (or at least 60, 70, 80, 90, 95, or 99 wt. %) of the SOₓ additive fragments have a particle size of greater than 0.5 μm (19.69 μin).

In embodiments, the process for cracking a sulfur-containing hydrocarbon feed in the absence of externally supplied molecular hydrogen includes the steps of: cycling an inventory of particulate solids including acidic cracking catalyst particles between a cracking zone and a catalyst regeneration zone; cracking the sulfur-containing hydrocarbon feed in the cracking zone in contact with the cracking catalyst particles at cracking conditions including a temperature in the range from 425° Celsius (797 degree Fahrenheit) to 700° Celsius (1292 degree Fahrenheit), whereby sulfur-containing coke is deposited on the catalyst particles, and removing the hydrocarbon feed from the cracking zone; passing coke-containing catalyst particles from the cracking zone and an oxygen-containing gaseous fluid into the catalyst regeneration zone, burning the sulfur-containing coke therein at a temperature in the range from 538° Celsius (1000 degree Fahrenheit) to 816° Celsius (1501 degree Fahrenheit) to form a flue gas containing sulfur oxides, and removing the flue gas from the catalyst regeneration zone; forming a sulfur-containing solid in the regeneration zone by reacting the sulfur oxides with SOₓ additive particles, comprising at least one SOₓ active particulate, having particulate sizes in the range from 0.5 μm (19.69 μin) to 40 μm (1575 μin), or from 0.5 μm (19.69 μin) to 20 μm (787.4 μin), or from 1 μm (39.37 μin) to 20 μm (787.4 μin), or from 2.5 μm (98.43 μin) to 20 μm (787.4 μin), and a binder, in the particulate solids inventory other than the catalyst particles; returning the resulting coke-depleted catalyst particles from the catalyst regeneration zone to contact with the hydrocarbon feed in the cracking zone; and forming hydrogen sulfide in the cracking zone by contacting the sulfur-containing solid with the hydrocarbon feed.

In embodiments, a process for combusting a sulfur-containing material in a circulating bed of particulates, comprising: contacting a sulfur-containing material with an oxygen-containing gaseous fluid and producing a gaseous product comprising sulfur oxides; contacting the sulfur oxides with SOₓ additive particles comprising SOₓ active particulates and a binder; and forming sulfur-containing solids.

The foregoing detailed description of the invention, examples, and illustrative embodiments illustrate a preferred mode of carrying out the invention. It will be clear to those skilled in the art that other embodiments and obvious modifications, equivalents and variations of the invention can be employed and adapted to a variety of fluid catalytic cracking systems. Such modifications, alterations and adaptations are intended to be included within the scope of the appended claims.

What is claimed is:

1. Additive particles for use in a fluid catalytic cracking system, comprising active particulates and a binder material, wherein at least a portion of the active particulates are in a size range from 0.5 μm to 40 μm.

2. The particles of claim 1, wherein at least 50 wt. % of the active particulates are in a size range from 0.5 μm to 40 μm.

3. The particles of claim 1, wherein at least 90 wt. % of the active particulates are in a size range from 0.5 μm to 20 μm.

4. The particles of claim 1, wherein at least a portion of the additive particles are in a size range from 45 μm to 200 μm.

5. The particles of claim 1, wherein at least 50 wt. % of the additive particles are in a size range from 45 μm to 200 μm.

6. The particles of claim 1, wherein the binder material comprises alumina or an active source of alumina.

7. The particles of claim 1, wherein the additive particles comprise from 0.1 wt. % to 50 wt. % of the binder material.

8. The particles of claim 1, wherein the additive particles further comprise a matrix material.

9. The particles of claim 1, wherein the additive particles are SOₓ additive particles, comprising at least one SOₓ active particulate that is reactive with sulfur trioxide or sulfur dioxide and oxygen at fluid catalytic cracking regenerator conditions to form at least one sulfur-containing solid.

10. The particles of claim 9, wherein the at least one SOₓ active particulate comprises alumina, magnesia, or combinations thereof.

11. The particles of claim 9, wherein the at least one SOₓ active particulate comprises a magnesium-alumina spinel.

12. The particles of claim 9, wherein the at least one SOₓ active particulate comprises a magnesium-alumina spinel and a binder.

13. The particles of claim 9, wherein the SOₓ additive particles further comprise a binder selected from alumina, silica, magnesia, or combinations thereof.

14. The particles of claim 9, wherein the SOₓ additive particles further comprise a promoter.

15. The particles of claim 14, wherein the promoter comprises at least one metal selected from a rare earth metal, a noble metal, a base metal, or combinations thereof.

16. The particles of claim 14, wherein the promoter comprises cerium or lanthanum.

17. The particles of claim 14, wherein the promoter comprises platinum or palladium.

18. The particles of claim 14, wherein the promoter comprises vanadium.

19. The particles of claim 1, wherein the additive particles comprise catalytic cracking particles comprising at least one active cracking particulate and the binder material.

20. The particles of claim 19, wherein the binder material comprises alumina or an active source of alumina.

21. The particles of claim 19, wherein the at least one active cracking particulate comprises a zeolite.

22. The particles of claim 21, wherein the zeolite is selected from a group consisting of rare earth-exchanged X or Y, hydrogen Y, ultrastable Y, or ZSM-5.

23. A process for preparing additive particles comprising:
a. forming active particulates in a size range from 0.5 μm to 40 μm; and
b. combining at least a portion of the active particulates with a binder material to form additive particles in a size range from 45 μm to 200 μm.

24. The process of claim 23, wherein at least 50 wt. % of the active particulates are in a size range from 0.5 μm to 40 μm.

25. The process of claim 23, wherein at least 50 wt. % of the additive particles are in a size range from 45 μm to 200 μm.

26. The process of claim 23, wherein forming active particulates comprises:
a. combining a reactive component selected from a group consisting of alumina, an active source of alumina, magnesia, an active source of magnesia, and combinations thereof, with a liquid to form a slurry; and
b. spray drying the slurry to form the active particulates.

27. The process of claim 23, wherein forming active particulates comprises:
a. preparing a blend of alumina or an active source of alumina and magnesia or an active source of magnesia;
b. drying the blend to form self-supporting particulates; and
c. grinding the self-supporting particulates to form the active particulates.

28. The process of claim 23, wherein forming additive particles comprises:
a. suspending the active particulates in a liquid to form a slurry; and
b. spray drying the slurry to form the additive particles.

29. The process of claim 28, further comprising providing alumina or an active source of alumina to the liquid prior to spray drying the slurry.

30. A process comprising circulating a mixture of cracking catalyst and SOₓ additive particles within a fluid catalytic cracking unit which includes a catalyst regeneration unit, passing an oxygen-containing gaseous fluid through the catalyst regeneration unit, and producing a flue gas that contains particulate fragments, including catalyst fragments and SOₓ additive fragments, wherein at least 50 wt. % of the SOₓ additive fragments have a particle size of greater than 1 μm.

31. A process comprising circulating a mixture of cracking catalyst and SOₓ additive particles within a fluid catalytic cracking unit which includes a catalyst regeneration unit, passing an oxygen-containing gaseous fluid through the catalyst regeneration unit, and producing a flue gas that contains particulate fragments, including catalyst fragments and SOₓ additive fragments, the SOₓ additive particles comprising SOₓ active particulates and a binder, the SOₓ active particulates being in a size range from 0.5 μm to 40 μm.

32. A process for cracking a sulfur-containing hydrocarbon feed in an absence of externally supplied molecular hydrogen, comprising:
a. cycling an inventory of particulate solids including cracking catalyst particles between a cracking zone and a catalyst regeneration zone;
b. cracking the sulfur-containing hydrocarbon feed with the cracking catalyst particles in the cracking zone at cracking conditions comprising a temperature in a range from 425° to 700° Celsius to form cracked hydrocarbon fluid products that are removed from the cracking zone, whereby sulfur-containing coke is deposited on the cracking catalyst particles;
c. passing the cracking catalyst particles deposited with the sulfur-containing coke from the cracking zone and an oxygen-containing gaseous fluid into the catalyst regeneration zone, such that the sulfur-containing coke is burned in the catalyst regeneration zone at a temperature in a range from 538° to 816° Celsius to form coke-depleted cracking catalyst particles and a flue gas containing sulfur oxides, and removing the flue gas from the catalyst regeneration zone;
d. forming a sulfur-containing solid in the catalyst regeneration zone by reacting the sulfur oxides with SOₓ additive particles, comprising at least one SOₓ active particulate having a size range from 0.5 μm to 40 μm and a binder;
e. passing the coke-depleted cracking catalyst particles and the sulfur-containing solid from the catalyst regeneration zone to the cracking zone; and
f. forming hydrogen sulfide in the cracking zone by contacting the sulfur-containing solid with the hydrocarbon feed.

33. A process for combusting a sulfur-containing material in a circulating bed of particulates, comprising:
a. contacting a sulfur-containing material with an oxygen-containing gaseous fluid and producing a gaseous product comprising sulfur oxides;
b. contacting the sulfur oxides with SOₓ additive particles comprising SOₓ active particulates, having a size range from 0.5 μm to 40 μm, and a binder; and
c. forming sulfur-containing solids.
